(19) United States
(12) Patent Application Publication
(10) Pub. No.: US 2015/0155072 A1
(43) Pub. Date: Jun. 4, 2015

(54) POLYMER FORMULATIONS FOR USE IN CABLE JACKETING AND INSULATION

(71) Applicant: CERRO WIRE LLC, Hartselle, AL (US)

(72) Inventors: Dale L. Crawford, Priceville, AL (US); Stephen E. Mickey, Hartselle, AL (US); Richard C. Bennett, Decatur, AL (US); Kevin L. Dalrymple, Hartselle, AL (US)

(21) Appl. No.: 14/558,248

(22) Filed: Dec. 2, 2014

Related U.S. Application Data
(60) Provisional application No. 61/910,811, filed on Dec. 2, 2013.

(51) Int. Cl. H01B 3/44; H01B 13/14; H01B 7/295

(52) U.S. Cl. CPC H01B 3/441; H01B 7/295; H01B 13/14

(57) ABSTRACT

Polymer formulations that are flame resistant and contain particulate biorenewable material can be used as cable insulation and jacket layers. The polymer formulations can include a polyolefin resin, a flame retardant, and a particulate biorenewable material. The polymer formulation can be coated as a cover layer onto a core to form a cable.

### CROSS REFERENCE TO RELATED APPLICATIONS

This application claims priority to U.S. Provisional Patent Application No. 61/910,811, filed Dec. 2, 2013, the entire contents of which are incorporated by reference.

### FIELD OF THE INVENTION

The present technology relates to flame resistant polymeric materials that include particulate biorenewable material, and cables having layers made of such materials.

### BRIEF DESCRIPTION OF THE DRAWINGS

Specific examples have been chosen for purposes of illustration and description, and are shown in the accompanying drawings, forming a part of the specification.

FIG. 1 illustrates one example of a cable of the present technology.

FIG. 2 illustrates a second example of a cable of the present technology.

FIG. 3 is a flow chart for a method of forming a polymer formulation of the present technology.

FIG. 4 is a flow chart for a method of making a cable of the present technology.

### DETAILED DESCRIPTION

The polymer formulations, cables, and methods of the present technology provide cables having a layer of polymeric material that is flame resistant and includes particulate biorenewable material.

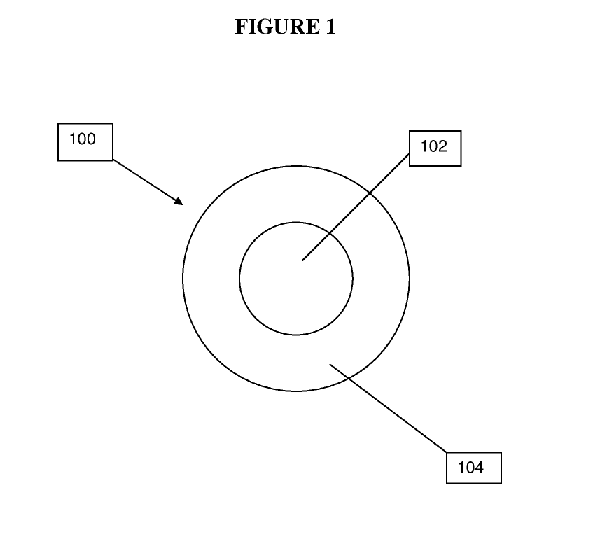

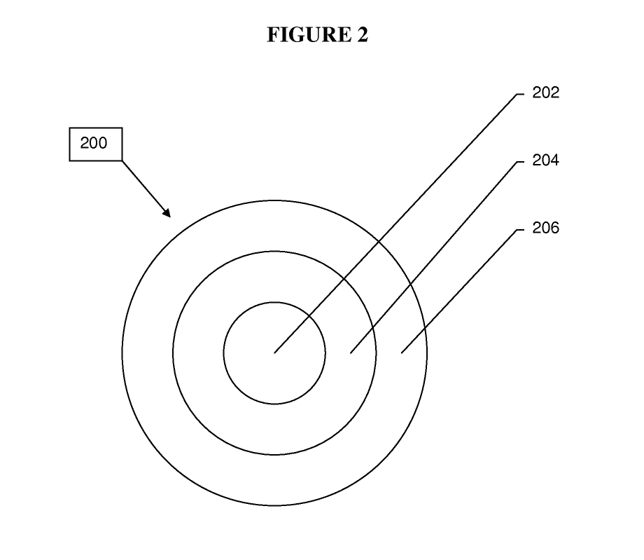

Wires and cables, referred to herein collectively as cables, of the present technology can have a basic configuration that includes at least one core and at least one cover layer on the core, which can be an insulation layer or a jacket layer. FIG. 1 illustrates one example of a cable 100, which includes a core 102, and a cover layer 104. Cables can include any suitable number of cover layers, and can include, for example, at least one insulation layer and at least one jacket layer. FIG. 2 illustrates one example of a cable 200, which includes a core 202, an insulation layer 204, and a jacket layer 206.

The core can include one or more wires or fiber optics. In examples where the cable is an electrical cable, the core can include one or more conductor wires that can each conduct electricity.

Polymer formulations of the present technology can be used to form one or more cover layers of a cable. For example, polymer formulations of the present technology can be used to form an insulation layer or a jacket layer.

Polymer formulations of the present technology include a polyolefin resin, a flame retardant, and a particulate biorenewable material. In some examples, such as where the flame retardant is an intumescent, polymer formulations of the present technology can also include an intumescent extender, which is an additive that provides additional carbon, acid or inert gas availability to the intumescent system, thus reducing the amount of intumescent needed and making the system less costly and easier to manufacture. Polymer formulations of the present technology can also include one or more additional additives, such as pigments, fillers, stabilizers, compatibilizers, elastomers, plasticizers, and lubricants, and combinations thereof.

In some examples, polymer formulations of the present technology can include a compatibilizer in an amount equal to or less than about 10% by weight of the polymer formulation, such as from about 0.1% by weight to about 10% by weight of the polymer formulation, which can facilitate the components of the polymer formulation being compounded into a homogeneous system. Examples of compatibilizers include maleic anhydride, maleated polyolefins, polycaprolactones, soybean oil, epoxidized soybean oil, and combinations thereof. At least some compatibilizers, such as soybean oil, epoxidized soybean oil, can be derived from a biorenewable resource, such as biomass.

In some examples, polymer formulations of the present technology can include an elastomer in an amount equal to or less than about 10% by weight of the polymer formulation, such as from about 0.1% by weight to about 10% by weight of the polymer formulation. One example of an elastomer is ethylene-propylene-diene-monomer (EPDM) elastomer. Because ethylene and propylene can both be derived from biorenewable resources, such as biomass, as discussed below, the ethylene-propylene-diene-monomer (EPDM) elastomer, or a portion thereof, can be derived from biorenewable resources.

The polyolefin resin can be the base component of a polymer formulation of the present technology. The polyolefin resin preferably has sufficient elongation, and is sufficiently soft, to be able to take the loading of the flame retardant and the particulate biorenewable material and still have useful properties after integration of these components. Polyolefin resins that can be used in polymer formulations of the present technology can include polymers of thermoplastic vulcanizates (TPV), propylene, ethylene, ethylene vinyl acetate (EVA), copolymers thereof, and combinations thereof. Suitable polymers and copolymers of ethylene and propylene include, for example polyethylene (PE), polypropylene (PP), ethylene-propylene copolymers, blends of polyethylene and polypropylene. Polyolefin resins that can be used in polymer formulations of the present technology can also include styrene in an amount of up to about 20% by weight of the polyolefin resin.

Polyolefin resins can be derived from biorenewable sources. This can be achieved, for example, by making monomers, from biorenewable resources, such as corn, sugar cane, or any other suitable biomass, and, for example, ethanol can be made from corn or sugar cane, and can then be dehydrated to form ethylene, and the ethylene can then be polymerized to make polyethylene. Propylene can also be derived from biomass.

The polyolefin resin can be present in the polymer formulation in an amount that is from about 10% by weight to about 80% by weight of the of the polymer formulation, including from about 20% by weight to about 80% by weight of the polymer formulation. For example, the polyolefin resin can be present in an amount that is about 10%, about 15%, about 20%, about 25%, about 30%, about 35%, about 40%, about 45%, about 50%, about 55%, about 60%, about 65%, about 70%, about 75%, or about 80%, by weight of the of the polymer formulation. Flame retardants that can be used in polymer formulations of the present technology include: halogenated flame retardants, metal hydroxides such as Mg(OH)2, melamines, melamine derivatives, phosphorous, phosphorous compounds, nitrogen containing flame retardants, inorganics, intumescents, combinations of carbon donors and acid donors, and combinations thereof. In one example, the flame retardant can include a mixture containing and combination of a metal hydroxide, melamine, a melamine derivative, and/or a phosphorus compound. In some examples, such as when the flame retardant includes a phosphorous or phosphorous compound, at least a portion of the flame retardant can be derived from a biorenewable resource, such as biomass.

Any intumescent enhancers used in the polymer formulation are also considered to be part of the flame retardant, and the amounts of flame retardant discussed herein can include intumescent enhancers. Halogenated flame retardants include, for example, bromine, chlorine, etc., and interrupt the combustion process. Phosphorous chars and releases water. Nitrogen containing flame retardants, which can be melamine containing substances, produce the inert gases ammonia and nitrogen under flame conditions. Inorganics include, for example, aluminum trihydrate (ATH), magnesium hydroxide (MOH), zinc borate, and antimony trioxide (ATO), and function by cooling the polymer, forming a char layer, and diluting the combustion gases. Intumescents retard fire by making foams that insulate the combustible substrate and form an oxygen barrier. For combinations of carbon donors and acid donors, examples of carbon donors include polyalcohols of starch, and examples of acid donors include ammonium phosphate, and spumific compounds, which include melamine components.

In examples where the flame retardant is an intumescent, there are coated intumescents and non-coated intumescents that can be suitable for use in the present technology. Coated intumescents are coated with a coating to prevent the intumescent from absorbing water and interfering with electrical properties. One example of a coating is a phenolic.

In some examples, the flame retardant is a non-halogen containing (i.e., halogen free) flame retardant.

The flame retardant can be present in the polymer formulation in an amount that is from about 5% by weight to about 50% by weight of the of the polymer formulation, including from about 5% by weight to about 40% by weight of the polymer formulation. For example, the flame retardant can be present in an amount that is about 5%, about 10%, about 15%, about 20%, about 25%, about 30%, about 35%, about 40%, about 45%, or about 50%, by weight of the of the polymer formulation.

Particulate biorenewable materials that can be used in polymer formulations of the present technology include: starch, algae, soybean oil, corn oil, rape seed oil, castor bean oil, various molecular weight sugars, sugar alcohols, cellulosics, alkylated cellulosics (e.g., ethylcellulose), saw dust, certain biorenewable polyesters such as polylactic acid (PLA), and other polymers having lactic acid incorporated into their backbone structure, and combinations thereof.

In one example, the particulate biorenewable material includes starch and algae. Starch and algae have a natural flame retardant aspect to them, thus enhancing the flame resistant properties of the polymeric formulation. Without being bound by any particular theory, it is believed that the starch and algae will be a carbon donor and promote charring. Starch and algae also decompose at a very high temperature (approximately 160 degrees Celcius) to generate water, which may help extinguish the combustion process. One example of a starch based particulate biorenewable material is Terratek Flex GDH-B1 from Green Dot Holdings, in Cottonwood Falls, Kans. This particular material is also an elastomer which can contribute to the desirable elastomeric properties of the compounded material.

Particulate biorenewable materials can have a particle size that is suitable for incorporation into the polymer formulation. For example, particulate biorenewable materials can have an average mean particle size that is equal to or less than about 0.1 millimeters.

The particulate biorenewable material can be present in the polymer formulation in an amount that is from about 0.1% by weight to about 50% by weight of the polymer formulation, including from about 0.1% by weight to about 40% by weight of the polymer formulation. For example, the particulate biorenewable material can be present in an amount that is about 0.1%, 0.2%, 0.5%, 1%, about 2%, about 5%, about 10%, about 15%, about 20%, about 25%, about 30%, about 35%, about 40%, about 45%, or about 50%, by weight of the polymer formulation.

One example of a polymer formulation of the present technology includes: a polyolefin resin present in an amount from about 10% to about 80% by weight of the polymer formulation, a flame retardant present in an amount from about 5% to about 50% by weight of the polymer formulation, and a particulate biorenewable material present in an amount from about 1% to about 50% by weight of the polymer formulation.

Another example of a polymer formulation of the present technology includes: a polyolefin resin present in an amount from about 20% to about 80% by weight of the polymer formulation, a flame retardant present in an amount from about 5% to about 40% by weight of the polymer formulation, and a particulate biorenewable material present in an amount from about 0.1% to about 40% by weight of the polymer formulation.

In some examples, polymer formulations of the present technology contain at least about 30% by weight of biorenewable materials. The particulate biorenewable material is one example of a biorenewable material that is included in the polymer formulation. Polyolefin resins derived from ethanol are another example of a biorenewable material that can be included in the polymer formulation.

Methods of forming polymer formulations of the present technology include combining the polyolefin resin, the flame retardant, and the particulate biorenewable material, and compounding the combined components to blend and mix the components together to form the polymer formulation. The final polymer formulation is preferably a homogeneous system.

Due to the inorganic nature of the flame retardant materials, they may not easily be miscible in the organic polyolefin resin. This may limit the amount of flame retardant that can be put into the system in one compounding step. Methods of forming polymer formulations of the present technology can thus include combining at least a first portion of each of the polyolefin resin, the flame retardant, and the particulate biorenewable material, and compounding the first portion of the components to form an intermediate polymer formulation, and then adding at least a second portion of any of the components, and compounding the second portion with the first portion. For example, the polyolefin resin and the particulate biorenewable material can be combined with a first portion of the flame retardant, and a first compounding step can be used to compound this first portion of the polymer formulation. A second portion of the flame retardant can then be added to the compounded first portion of the polymer formulation, and a second compounding step can be performed. If desired, any of the components can be divided into any number of portions, and the components can be combined and compounded in any number of combining and compounding steps.

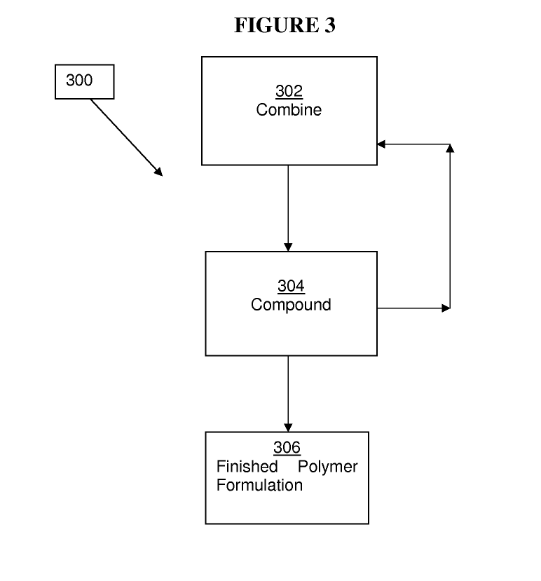

FIG. 3 is a flow chart showing one method 300 of forming a polymer formulation of the present technology. The method 300 includes a combining step 302, in which at least a portion of each of the polyolefin resin, the flame retardant, and the particulate biorenewable material are combined. Any additional additives, or portions thereof, can also be combined in combining step 302. In compounding step 304, the portion of the components that was combined in step 302 is compounded. If desired, steps 302 and 304 can be repeated, until all of the components are compounded and a final, preferably homogeneous, polymer formulation is produced at step 306.

Compounding equipment that can be suitable for use in the compounding steps of the present technology include twin screw compounding, planetary screw compounding, or other high mixing methods.

Methods of forming cables of the present technology include coating a core with a cover layer of the polymer formulation. The cover layer of the polymer formulation can be coated directly onto the core, or the core may be encased in one or more other cover layers. In at least one example, the coating can be performed by extruding the polymer formulation onto the core.

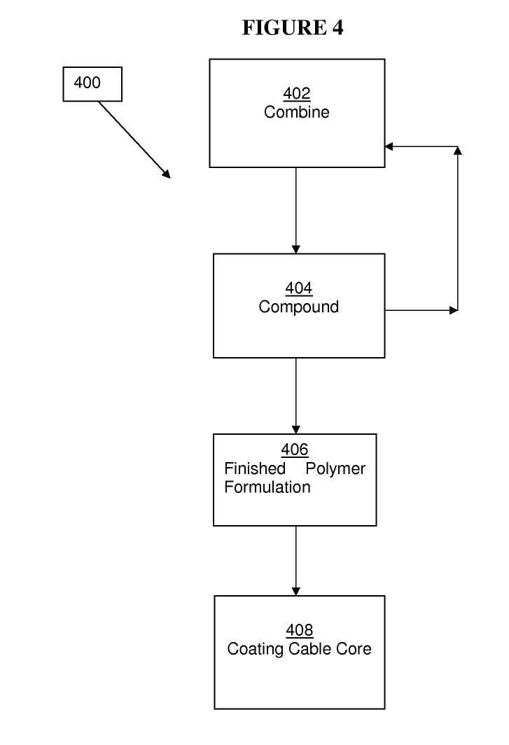

FIG. 4 is a flow chart showing one method 400 of forming a cable of the present technology, which includes forming the polymer formulation as described in FIG. 3. The method 400 includes a combining step 402, in which at least a portion of each of the polyolefin resin, the flame retardant, and the particulate biorenewable material are combined. Any additional additives, or portions thereof, can also be combined in combining step 402. In compounding step 404, the portion of the components that was combined in step 402 is compounded. If desired, steps 402 and 404 can be repeated, until all of the components are compounded and a final, preferably homogeneous, polymer formulation is produced at step 406. Then, at coating step 408, a cover layer of the final polymer formulation is coated onto a core of the cable, which may or may not include other cover layers.

In one method of manufacturing a cable of the present technology, an extruder can be provided that compounds the polymer formulation and coats the core in one step, or in immediately subsequent steps.

From the foregoing, it will be appreciated that although specific examples have been described herein for purposes of illustration, various modifications may be made without deviating from the spirit or scope of this disclosure. It is therefore intended that the foregoing detailed description be regarded as illustrative rather than limiting, and that it be understood that it is the following claims, including all equivalents, that are intended to particularly point out and distinctly claim the claimed subject matter.

What is claimed is:

1. A polymer formulation for use as a cover layer in a cable, the polymer formulation comprising:
a polyolefin resin in an amount from about 10% by weight to about 80% by weight of the polymer formulation;
a fire retardant in an amount from about 5% by weight to about 50% by weight of the polymer formulation; and
a particulate biorenewable material in an amount from about 0.1% by weight to about 50% by weight of the polymer formulation.

2. The polymer formulation of claim 1, wherein the particulate biorenewable material has an average mean particle size of less than 0.1 millimeters.

3. The polymer formulation of claim 1, further comprising at least one additive selected from the group consisting of intumescent extenders, pigments, fillers, stabilizers, compatibilizers, plasticizers, and lubricants, and combinations thereof.

4. The polymer formulation of claim 3, further comprising a compatibilizer in an amount equal to or less than about 10% by weight of the polymer formulation.

5. The polymer formulation of claim 3, wherein the compatibilizer is selected from the group consisting of maleic anhydride, maleated polyolefins, polycaprolactones, soybean oil, epoxidized soybean oil, and combinations thereof.

6. The polymer formulation of claim 1, comprising:
a polyolefin resin in an amount from about 20% by weight to about 80% by weight of the polymer formulation;
a fire retardant in an amount from about 5% by weight to about 40% by weight of the polymer formulation; and
a particulate biorenewable material in an amount from about 0.1% by weight to about 40% by weight of the polymer formulation.

7. The polymer formulation of claim 1, wherein the polyolefin resin is selected from the group consisting of polymers of thermoplastic vulcanizates (TPV), propylene, ethylene, ethylene vinyl acetate (EVA), copolymers thereof, and combinations thereof.

8. The polymer formulation of claim 1, wherein the polymer formulation comprises biorenewable materials in an amount of at least about 30% by weight of the polymer formulation.

9. The polymer formulation of claim 1, wherein the polyolefin resin comprises a polymer formed of monomers derived from biomass.

10. The polymer formulation of claim 1, further comprising an ethylene-propylene-diene-monomer (EPDM) elastomer in an amount equal to or less than about 10% by weight of the polymer formulation.

11. The polymer formulation of claim 10, wherein at least a portion of the ethylene-propylene-diene-monomer (EPDM) elastomer is derived from biomass.

12. The polymer formulation of claim 1, wherein the particulate biorenewable material is at least partially derived from biomass.

13. The polymer formulation of claim 1, wherein the particulate biorenewable material is selected from the group consisting of starch, algae, soybean oil, corn oil, rape seed oil, castor bean oil, sugars, sugar alcohols, cellulosics, alkylated cellulosics, saw dust, polylactic acid (PLA), and combinations thereof.

14. The polymer formulation of claim 1, wherein the flame retardant is selected from the group consisting of halogenated flame retardants, metal hydroxides such as Mg(OH)2, melamines, melamine derivatives phosphorous, phosphorous compounds, nitrogen containing flame retardants, inorganics, intumescents, combinations of carbon donors and acid donors, and combinations thereof.

14. The polymer formulation of claim 1, wherein the flame retardant is a non-halogen containing flame retardant.

15. The polymer formulation of claim 1, wherein at least a portion of the flame retardant is derived from biomass.

16. The polymer formulation of claim 1, wherein the polymer formulation is a homogeneous mixture.

17. A method of making a polymer formulation for use as a cover layer in a cable, the method comprising steps of:
combining components comprising polyolefin resin, flame retardant, and particulate biorenewable material; and
compounding the combined components to form the polymer formulation.

18. The method of claim 17, wherein the method comprises steps of:
combining a first portion of components, the first portion comprising polyolefin resin, a first portion of flame retardant, and a first portion of particulate biorenewable material;
compounding the combined components to form an intermediate polymer formulation;
combining a second portion of components, the second portion comprising at least one of polyolefin resin, flame retardant, and particulate biorenewable material; and
compounding the combined intermediate polymer formulation and the second portion of components to form the polymer formulation.

19. A method of making a cable having a polymer formulation as a cover layer in a cable, the polymer formulation, the method comprising steps of:
providing a polymer formulation comprising polyolefin resin, flame retardant, and particulate biorenewable material; and
coating a cover layer of the polymer formulation onto a core.

20. The method of claim 19, wherein the coating step includes extruding the cover layer of the polymer formulation onto the core.
